(19) United States
(12) Patent Application Publication
(10) Pub. No.: US 2017/0297206 A1
(43) Pub. Date: Oct. 19, 2017

(54) MEASURING DISTANCE AND CONTACT FORCE DURING ROBOTIC MANIPULATION

(71) Applicant: The Regents of the University of Colorado, a body corporate, Denver, CO (US)

(72) Inventor: Nikolaus Correll, Boulder, CO (US)

(73) Assignee: The Regents of the University of Colorado, a body corporate, Denver, CO (US)

(21) Appl. No.: 15/487,463

(22) Filed: Apr. 14, 2017

Related U.S. Application Data
(60) Provisional application No. 62/322,469, filed on Apr. 14, 2016.

(51) Int. Cl. B25J 13/08; G01L 5/22; G01L 1/24; G01S 17/08

(52) U.S. Cl. CPC B25J 13/085; G01S 17/08; B25J 13/086; G01L 1/248; G01L 5/228

(57) ABSTRACT

A force, distance and contact measurement system comprising at least one low-cost tactile sensor embedded in elastomer and retrofitted onto existing robotic grippers is provided. The sensor is simple to manufacture and easy to integrate with existing hardware. The sensor can be arranged in strips and arrays, facilitating manipulation tasks in uncertain environments. The elastomer protects the sensor, provides a rugged and low-friction surface, and allows performing force measurements.

### CROSS-REFERENCE TO RELATED PATENT APPLICATIONS

This application claims the benefit of U.S. Provisional Application No. 62/322,469, filed on Apr. 14, 2016 which is herein incorporated by reference in its entirety.

### ACKNOWLEDGEMENTS

This invention was made with government support under grant number FA9550-15-1-0238, awarded by the U.S. Air Force. The government has certain rights in the invention.

### FIELD OF THE INVENTION

The present invention relates generally a system that can be used to measure force, distance and/or contact during robotic manipulation. More specifically, the present invention relates to a measurement system comprising a low-cost tactile sensor that combines force and distance measurements and can be retro-fitted to existing robotic grippers and hands.

### BACKGROUND OF THE INVENTION

Grasping and manipulation remain hard challenges in robotics. After identifying an object's pose, a robot's end-effector needs to be controlled so that impact with the object provides a sufficient number of constraints for successful pick-up while maintaining the object's pose until all desired contact points are reached, thereby preventing the object from moving out of the end-effector's reach. There exist complementary approaches to tackle subsets of the grasping problem, ranging from relying on compliance of the gripper's material, pushing the object to exploit environmental constraints, obtaining a precise 3D model of the object and calculating an appropriate grasp, to using visual servoing to make up for uncertainty in sensing and actuation. In practice, each class of solutions addresses a very narrow range of problems and presents distinct challenges. For example, most compliant hands exclusively rely on compliance to successfully grasp an object once its pose has been determined. Touch sensors have been used to determine whether the grasp is successful, but cannot be used to improve the grasp prior to contact. Exploiting environmental constraints such as walls or a bowl has been shown to increase grasping success, but planning such a motion requires precise knowledge of the environment's geometry and would benefit from active sensing to determine whether an object has reached a desired pose. Using 3D sensing suffers from uncertainty in both sensing and actuation, making reliable grasps very difficult, regardless of the type of end-effector used. While visual servoing might help alleviate this challenge by allowing to make up for errors in sensing and actuation, it requires precise registration of an object's geometry, which is difficult in particular when the hand comes close to the object and thereby shields it from external sensors mounted on the wrist or elsewhere on the robot.

Combining compliance, planning and reactive control is a promising avenue. Using simple infrared distance sensors within a robotic gripper for reactive control during the final phase of grasping has been proposed. Similarly, reactive control can be based on finger torque, curvature or contact itself, which can be achieved by a large number of sensing modalities ranging from capacitive to resistive and optical. Commercially successful systems (that is, widely deployed) in-hand sensors however are virtually non-existing as of yet as they are difficult to manufacture and expensive. At the same time, the algorithmic foundations for reactive grasp planning are only sparsely developed, with most of the focus on the sense-plan-act model that requires precise sensing and actuation.

While there exist a myriad of both distance and pressure sensors, none of them are commercially successful as they are costly to manufacture and often impractical to use. The dominating paradigm for locating objects and determining grasp points is therefore to use external sensors such as cameras and depth sensors. These sensors do not have sufficient resolution and fail in cluttered or hard-to-reach environments, such as reaching inside a shelf.

Accordingly, it is desirable to provide a low-cost measurement system and method to measure force, distance and/or contact during robotic manipulation using commodity infrared proximity sensors.

### SUMMARY

Presented herein is a measurement system comprising at least one low-cost tactile sensor embedded in elastomer that combines force and distance measurements. The proposed sensor can be simple to manufacture and easy to integrate with existing hardware. The invention also comprises a low-cost method to measure force, distance and/or contact using at least one commodity infrared proximity sensor that can be retro-fitted to existing robotic grippers and hands. The sensor can be less than 1 cm² and can be arranged in strips and arrays, drastically facilitating manipulation tasks in uncertain environments. The elastomer can protect the sensor, provide a rugged and low-friction surface, as well as allow performing force measurements using Hooke's law.

The sensor comprises a commodity digital infrared distance sensor that is embedded in a soft polymer, which doubles as a spring for force measurements based on Hooke's law. The strong dependence of infrared-based sensors on surface properties can be overcome by exploiting the discontinuity that the elastomer coating introduces into the sensor response.

Related methods of operation are also provided. Other apparatuses, methods, systems, features, and advantages of the force, distance and/or contact measurement system will be or become apparent to one with skill in the art upon examination of the following figures and detailed description. It is intended that all such additional apparatuses, methods, systems, features, and advantages be included within this description, be within the scope of the force, distance and/or contact measurement system, and be protected by the accompanying claims.

### DESCRIPTION OF THE FIGURES

FIG. 1 is a perspective view of the system for measuring force, distance and/or contact during robotic manipulation of the present application, showing at least one sensor embedded in a polymer and positioned on a robotic gripper, according to one aspect;

FIG. 2 is a schematic diagram of the system of FIG. 1;

FIGS. 3A-3C illustrate a process for manufacturing the system of FIG. 1;

FIG. 4 is a perspective view of an experimental setup to test the system of FIG. 1;

FIGS. 5A-5C are charts illustrating the sensor responses for different design parameters of the sensor of FIG. 1;

FIGS. 6A-6D are charts illustrating the sensor responses for different color targets and target distances for the sensor of FIG. 1;

FIG. 7A is a perspective view of the system of FIG. 1 in which the gripper is attempting to grasp a cube;

FIG. 7B is a chart illustrating the values sensed by the left and right gripper as the grippers approach the cube of FIG. 7A;

FIG. 8 is a chart illustrating the difference between the left gripper and the right gripper in FIG. 7B;

FIG. 9A is a chart illustrating the values sensed by the left gripper as the gripper approaches the pan of FIG. 10A, FIG. 9B illustrates raw values of the contact data for the fifth sensor of the right gripper, FIG. 9C illustrates calibration data for black cardboard, and FIG. 9D is a chart illustrating the values sensed by the right gripper as the gripper approaches the pan of FIG. 10A;

FIGS. 10A and 10B are perspective views of the system of FIG. 1 in which the gripper is attempting to grasp a pan;

FIG. 11 is a 3D point cloud model of a cup created by date collected by the system of FIG. 1;

FIGS. 12A-12B are perspective views of the system of FIG. 1 in which the gripper is attempting to grasp a toy airplane;

FIGS. 13A is a chart illustrating the estimation of possible grasp location of the YCB airplane for the left finger of the system of FIG. 1;

FIGS. 13B is a chart illustrating the estimation of possible grasp location of the YCB airplane for the right finger of the system of FIG. 1; and

FIG. 14 is a perspective view of the system for measuring force, distance and/or contact during robotic manipulation of the present application, comprising a 4×8 sensor array embedded in a polymer and positioned on a robotic gripper, according to one aspect.

### DESCRIPTION OF THE INVENTION

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “sensor” includes aspects having two or more such sensors unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

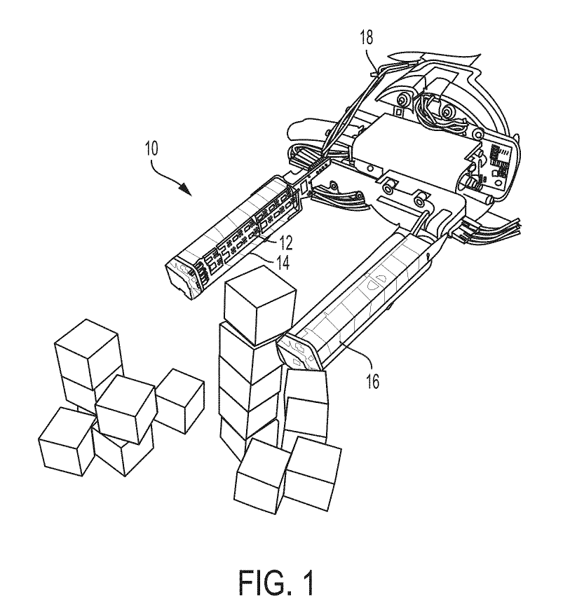

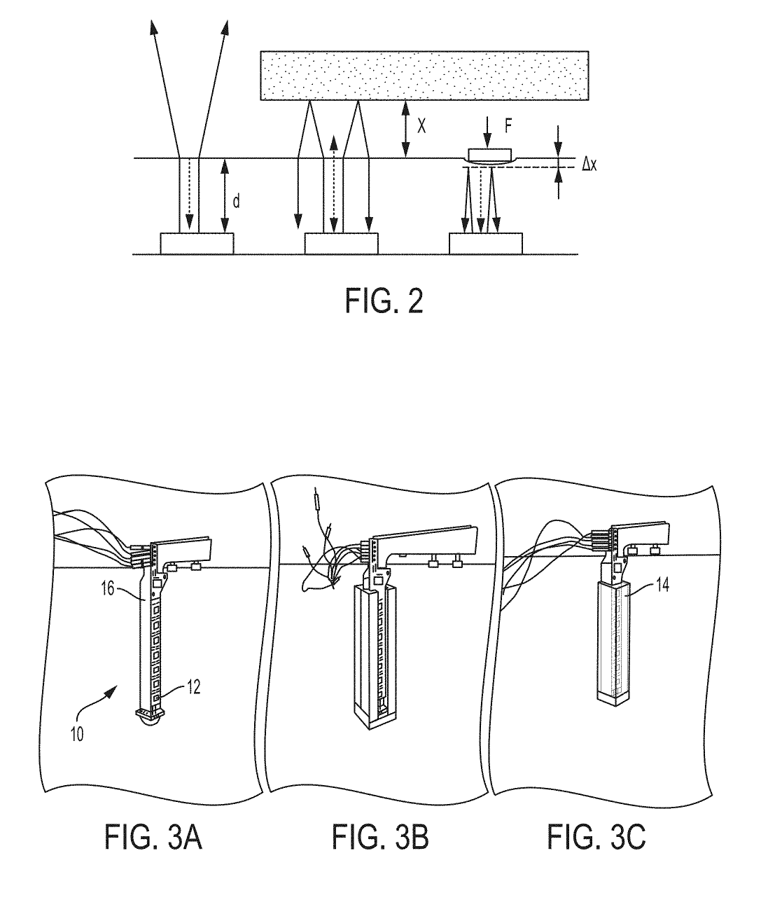

The application relates to systems and methods for measuring force, distance and contact during robotic manipulation. In one aspect, the system 10 comprises at least one infrared proximity sensor 12 embedded in a polymer 14 as illustrated in FIG. 1. The at least one embedded sensor can be positioned on a conventional robotic gripper 16 and/or hand. In another aspect, the at least one infrared proximity sensor 12 can comprises a plurality or proximity sensors arranged in strips, arrays and/or other predetermined patterns embedded in a polymer and positioned on the robotic gripper. For example, the system of FIG. 1 shows two sensor arrays mounted to the parallel gripper 16 of a “Baxter” robot 18 (Rethink Robotics, Boston, Mass.), such that a first array can be mounted to a first finger of the gripper and a second array can be mounted to a second finger of the gripper. The ability to select the frequency of each sensor allows one to arrange sensors in opposite pairs, such as on a robotic gripper, without interference. The at least one sensor can provide force, distance and/or contact measurements to a processor for further manipulation and to provide feedback regarding the robotic gripper.

As used herein, the term “contact” means the event when both distance and force are zero. For example, a robot contacts an object to be manipulated when the distance from the robot to the object is zero, and when the force exerted by the robot on the object is zero.

Infrared sensors can be strongly non-linear, dependent on the surface properties of sensed objects, and sensitive to cross-talk from other sensors or infrared light in the environment. Increasing use in consumer electronics such as smart phones has led to a new generation of devices that improve cross-sensitivity by integrating sensor and emitter with digital signal processing.

In one aspect, the sensor 12 can be an integrated proximity and ambient light sensor such as, for example and without limitation, a VCNL 4010 sensor marketed by Vishay Semiconductors. This device has a relatively miniature 3.95×3.95×0.75 mm³ package which combines an infrared emitter and PIN photodiode for proximity measurement, ambient light sensor, a signal processing IC, a 16 bit ADC, and inter-integrated-circuit (I²C) communication interface. The chip allows setting a large variety of parameters. For example, one parameter can be the emitter current (20 mA to 200 mA in increments of 10 mA). In another example, a parameter can be the carrier frequency in the range from 390.625 kHz-3.125 MHz in four increments. The emitter current should not be confused with the actual power consumption, which is less than 4 mA when performing 250 measurements per second at full (200 mA) power, and in the order of μA when doing 10 or less measurements per second.

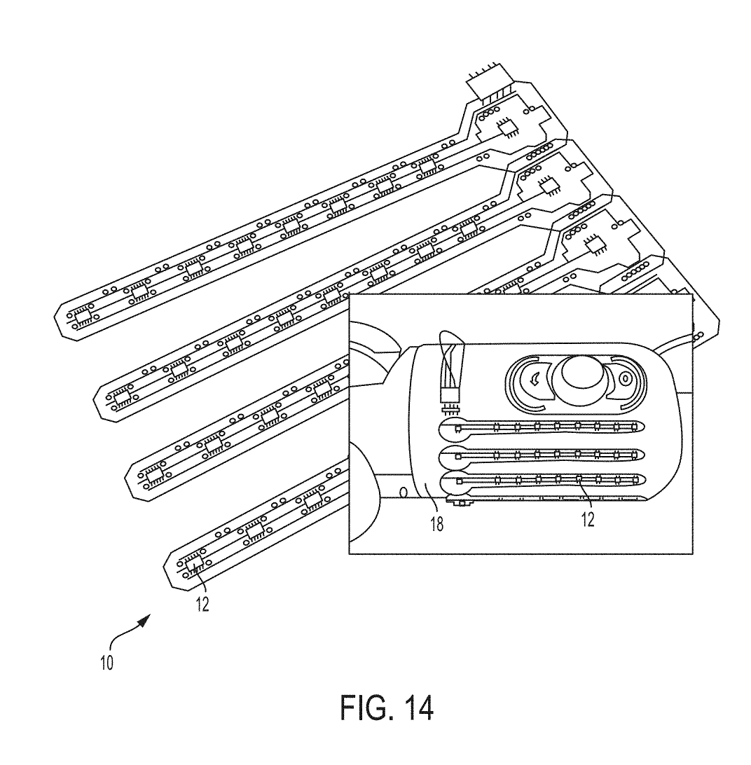

In one aspect, the at least one sensor 12 can be a single embedded sensor. In other aspects, the sensor can comprise a plurality of embedded sensors arranged in an array. That is, the plurality of sensors 12 can be arranged in n x m array, where n and m can be one, two, three, four, five, six, seven, eight, none, ten or more than ten. For example, the plurality of sensors can be arranged in a 1×8 array positioned on the finger of a gripper 16, an 8×8 array positioned on the hand of a gripper, a 20×20 array positioned on a gripper and the like. In another example, the system of FIG. 14 shows a 4×8 sensor array mounted to a Baxter robot. In this example, a second array (not shown) could be interleaved to create a dense 8×8 sensor array. In one aspect, the sensors 12 can be arranged in groups of eight using an I²C multiplexer (TCA9548A, Texas Instrument). This chip has a 3-bit address supporting arrays of up to 8×8 sensors. At 100 kHz /²C bus frequency, a single measurement can require 1470 ,μs including communication, allowing to read an 8×8 array at 10 Hz and a strip of eight at 85 Hz.

Each sensor 12 can be embedded in a polymer, such as for example and without limitation, an elastomer 14. In one aspect, the polymer can be a transparent polymer (to infrared light) when cured. That is, the sensor can be embedded in a polymer that is transparent to the sensor 12. In another aspect, the polymer 14 can be, for example and without limitation, polydimethylsiloxane, (“PDMS”) such as Dow Corning Sylgard 184 and the like. PDMS is a widely used silicon elastomer, whose mechanical and optical properties are known. PDMS is simple to manufacture and cheap, while providing good transparency and mechanical properties such as resistance to chemical and mechanical abrasion. The elastomer can protect the sensor and provide a rugged and low-friction surface, as well as allow performing force measurements using Hooke's law. Further, adding the elastomer introduces an infliction point in sensor response upon contact which can be detected by simple signal processing. It can therefore possible to determine contact independently of the surface properties, as well as calibrating the sensor on the fly.

The integrated infrared emitter of the sensor 12 has a peak wavelength. For example, if the sensor is a VCNL 4010, the peak wavelength can be about 890 nm. The light from the emitter passes through the PDMS in which the sensor is embedded. The emitted light can then reflected by nearby objects and received by a photo-receiver of the sensor. The amplitude and phase of the received light vary as a function of the distance to the surface, and the surface orientation, color and texture.

Due to the quadratic decay of light amplitude with distance, the sensor 12 can have its highest resolution right after its minimum range, for example 0.5 mm. It can therefore be possible to measure small variations in distance in the order of hundredths of millimeters. In one aspect, this effect can be exploited by measuring the elastic deformation that occurs when an object is pressed against the sensor. As the elastomer acts like a spring with a constant Young's modulus E, the force is given by

$$F \approx \frac{EA}{d} Δ x \qquad ( 1 )$$

with A the contact area over the sensor, d the width of the PDMS layer and Δx the measured deformation. Note that the sensor area can be constant and smaller than the actual contact area of typical objects. Yet, the value of F can be approximate as PDMS cannot be infinitely compressed and eventually changes its absorption properties.

Let the emitted light intensity be I₀ and the measured reflected intensity from an object be I. Let the thickness of the rubber be d and the distance to the object x. Depending on the index of refraction of the rubber material, a fraction R of the light will be reflected from the interface between rubber and air, a fraction κ will be scattered, and a fraction A will be absorbed at the target surface. Assuming that the light intensity decays quadratically with distance, the amount of returned infrared light can be approximated as

$${I}_{x > 0} \approx {I}_{0} ( 1 - R ) \frac{A}{{( d + x )}^{2}} + {I}_{0} R \frac{1}{{d}^{2}} - κ {I}_{0} . \qquad ( 2 )$$

The reflection at the PDMS/air interface can be calculated using the Fresnel equation, which reduces to

$$R = {\vert \frac{{n}_{1} - {n}_{2}}{{n}_{1} + {n}_{2}} \vert}^{2} \qquad ( 3 )$$

for normal incidence. With the refractive index of PDMS n₁≈1.41 and that of air n₂≈1, around 2.9% of the light can get reflected from the internal surface of the PDMS as well as on the outside on the return path.

This formalism helps to better understand certain edge cases. First, when d<<x, the light intensity at the receiver is dominated by I₀R 1/d², which leads to saturation of the sensor. The width d of the PDMS therefore governs the maximum current at which the sensor can be operated and thereby the maximum attainable range. At the same time, the width governs the maximum allowable Δx and thereby the maximum force and its resolution that the sensor can measure.

Once the object touches the sensor surface, i.e. x=0, (2) reduces to a constant which is a function of material properties. After touching, the PDMS gets compressed by

$$Δ x \approx \frac{dF}{EA} ,$$

leading to

$${I}_{x < 0} \approx {I}_{0} \frac{A}{{( d - \frac{dF}{EA} )}^{2}} - κ {I}_{0} \qquad ( 4 )$$

Note that (4) still depends on the surface reflectance A, which therefore needs to be known for accurate force measurements. As Iₓ₌₀=const and the derivative of (2) increasing when approaching zero, while the derivative of (4) decreasing, x=0 appears to be an inflection point, which possibly could be detected in recordings of I.

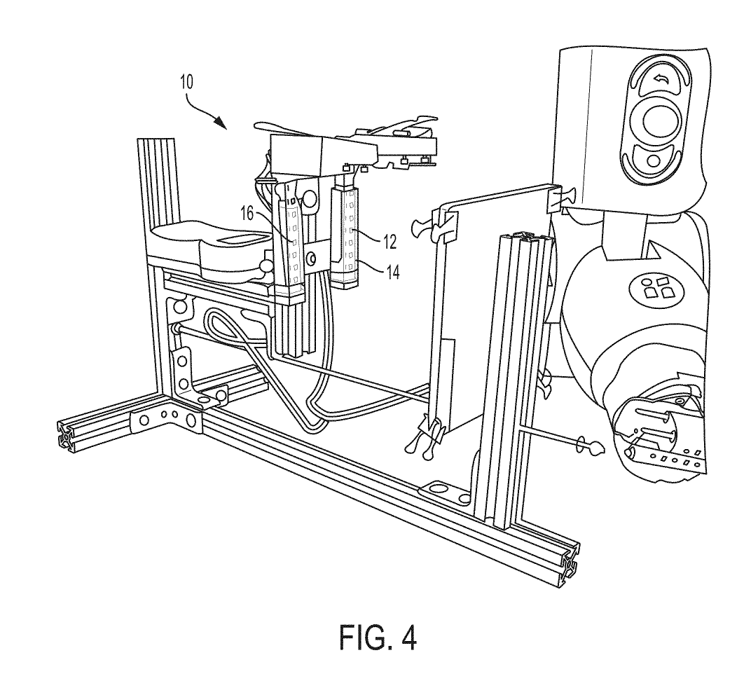

In one aspect, the at least one infrared sensor 12 requires few external components, such as, for example and without limitation, 3 capacitors. Encapsulation of the sensor in a polymer such as PDMS 14 can be readily accomplished by fixing the circuit board in a mold and pouring the liquid polymer in it. The elastomer then cures to form a robust and compliant rubber contact surface for grasping and manipulation. Illustrations of the process are shown in FIGS. 3A-3C.

In order to avoid air being trapped at the interface between PDMS 14 and the sensor 12, the assembly can be degassed in a vacuum chamber, according to one aspect. The PDMS can then be cured in an oven at 70° C. for about 20 minutes. To accurately study the optical properties of amorphous PDMS, it can be useful to purify the raw materials before the mixing process to avoid extrinsic losses, e.g. by particle scattering. The base material and coupling agents can thus be filtered using a cellulose-mix-ester membrane filter having a pore size of about 0.2 μm. The entire sensor preparation process can take around 5 hours per pair.

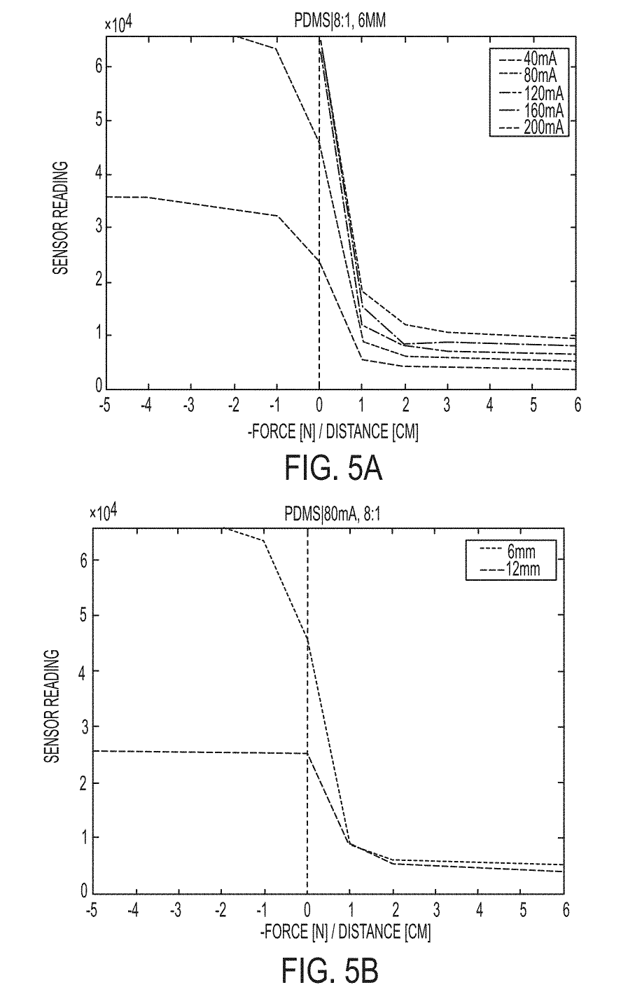

To experimentally characterize the performance of the proposed tactile sensor 12, the response of an individual sensor can first be characterized. Then the sensing capabilities of a complete array of sensors can be characterized by installing the array on a parallel gripper 16. FIG. 4 shows the experimental setup to test and characterize the performance of the sensors, according to one aspect. The setup can be designed in a way which allows the testing of both an individual taxel and complete arrays in their proximity and force regions. The setup comprises a 0.15×0.13 m² screen that can be mounted vertically on a sliding rod with precise linear control. A digital force gauge such as a Shimpo FGV-10XY and the like can be mounted horizontally on the opposite side of the screen to measure the force exerted on the sensor 12.

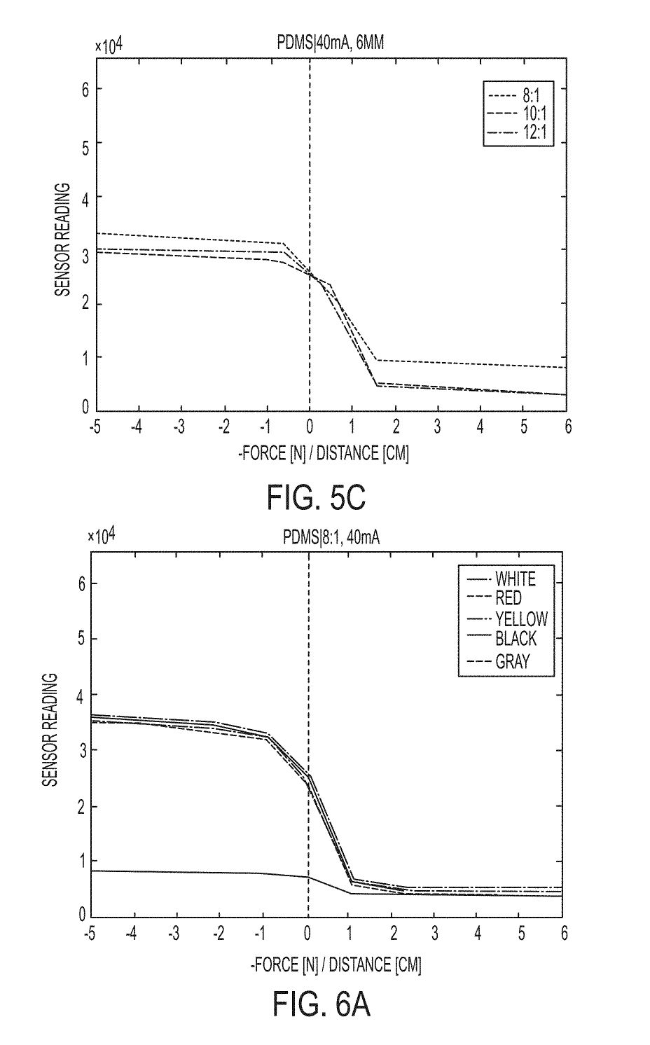

Single-point measurements at distances from 0 to 6 cm in increments of 1 cm can be recorded, as well as force from 1N to 5N in increments of 1N for current values from 40 mA to 200 mA in increments of 40 mA (FIG. 5A). Results show saturation of the sensor 12 for distances below about 1 cm at current values exceeding 80 mA due to Fresnel reflection inside the PDMS. At about 80 mA, the sensor can saturate at less than about 2N force, whereas a 40 mA setting can allows measurement across the range from 0 to 5N.

The thickness of PDMS 14 can have an effect on the amount of light absorbed and scattered within the PDMS material. However, the amount of light reflected back from the air-PDMS surface can remain the same regardless of the thickness of the PDMS as the amount of reflection can depend only on the refractive indexes of the material.

FIG. 5B shows the response of two sensors 12 cast in PDMS 14 with the base to curing agent in 8:1 ratio and thickness of 6 mm and 12 mm. A difference can be observed in the force reading. In one aspect, thicker PDMS can tend to allow the reading of higher force values, however thicker PDMS comes with the drawback of lessening the dynamic range, and thereby resolution, of the sensor 12 in the 0 to 5N region. As absorption within the material can be marginal, thickness does not significantly alter the proximity reading.

The mid-infrared transmission of thin PDMS film can be characterized using Fourier Transform Infrared (FT-IR) Spectrometry. The transmittance of infrared light can depend on the mixing ratio of two parts causing the composition of PDMS to change; for example, a lower mixing ratio can result in higher transmittance. Maximum transmittance of about 95% can be found between wavenumbers 2490-2231 cm⁻¹ with mixing ratios of 8:1. To compare the results at wavenumbers 12500-10526 cm⁻¹ (800-950 nm), three mixtures of PDMS with different mixing ratio of the base and curing agent (5:1, 10:1, and 12:1) were prepared. FIG. 5C shows the sensor proximity and force values for different mixing ratios. The Young's modulus of PDMS changes by about 35-40% where the density changes by 1% over the range of mixing ratio from 8:1 to 12:1. In one aspect, there can be a small difference in the force region among these values, and a more distinct distance measurement, in particular for 8:1 mixing ratios. As the cross-over from distance to force is at approximately the same sensor reading, 8:1 mixing ratios can provide the widest dynamic range in the force regime, but the smallest dynamic range in the distance regime.

For calibrating the relationship between the sensor 12 reading and actual distance, the sensitivity of the sensor to surface reflectance was characterized. The data for different distances across a variety of sensors for white paper was recorded. A width of 6 mm at a mixing rate of 8:1 was chosen due to the higher dynamic range in both the distance and force regime.

The intensity of light reflected from objects can be dependent on the color, pose and surface properties of the object. Five different colored target cardboard papers (red, yellow, white, gray and black, Canson, 150 gsm) were chosen. The colored cardboard papers were mounted on a screen shown in FIG. 4 which served as target objects for a distance sensor 12 coated by 6 mm PDMS at 8:1 mixing ratio.

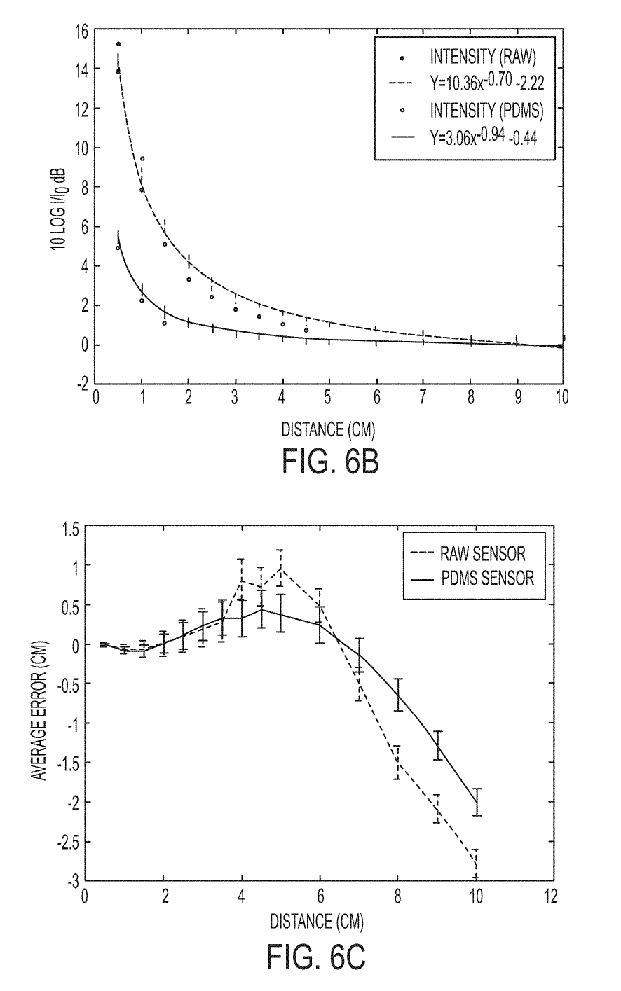

FIGS. 6A-6D show the response of the sensor 12 to different colors. The proximity measurements can be comparatively lesser influenced by the reflective properties of the target surface than the force measurements. While brightly colored materials can give better readings than darker ones, there is not necessarily any significance difference in the sensor response to different colors, except for the black paper.

The reflectance for a variety of colors can be in the range of 0.9 (gray) to 1.0 (white), whereas black cardboard has a reflectance of 0.12. Cardboard of all colors can be more reflective than wood (0.77), brick (0.61) or concrete (0.53), but less reflective than surfaces such as polished plastic or china.

In order to obtain a relationship between sensor 12 readings and actual distance, data from fourteen different sensors and white paper was recorded. Seven sensors were soldered in a line at 10 mm spacing to a rigid PCB as illustrated in FIG. 1. The response of two such fourteen sensor arrays was recorded at twenty-four distances ranging from 0.5 to 19 cm and 50 measurements each for 120 mA. While 120 mA leads to saturation in the force regime (when using white paper), this value allows obtaining better ranging and works with objects that are less reflecting. The data is shown in FIGS. 6A-6D.

This data was fitted with a function of the form y=ax^{b}+c using MATLAB's curve fitting toolbox's trustregion method and bisquare weighting of outliers. The candidate function corresponds to physical intuition (with b=−2) and can be inverted to

$$x = \frac{1}{{( ( y - c ) \text{/} a )}^{\frac{λ}{h}}} \qquad ( 5 )$$

Notice that the denominator of the above equation includes the b-th root, which yields complex values for y<c. This can be the case whenever a sensor 12 reading falls below the asymptote of the fitted curve, which can be the case for farther-away measurements. Therefore all measurements can be converted into a decibel scale using log₁₀ I/I_{∞}, where I_{∞} is the measurement obtained in plain air. With b≈−1 after fitting on the log-scale, all distance measurements remain real. The fit as well as absolute error for both the raw and PDMS-coated sensors are shown in FIG. 6C. A slightly higher absolute error for all measurements with PDMS can be observed, which initially makes objects appear closer (up to about 7 cm) and then farther apart than the raw sensor. Data follows a similar trend for distances from 10 cm to 19 cm, but are not shown as the high error at this range makes those measurements impractical to use.

As force measurement can be susceptive to surface reflectance, fits for a variety of colored papers were performed using data from FIG. 6A. Results for a subset (white, red, black) are shown in FIG. 6D. Using an equation of the form y=ax^{b} has provided good results, with R-squared values ranging from 0.9898 (black) to 0.9953 (white).

The at least one sensor 12 can be mounted on the parallel gripper 16 of a robot, such as for example and without limitation, the Baxter robot from Rethink Robotics, which is equipped with two 7-DOF arms. The size of each finger sensor can be 80×2×1 mm (FIG. 1), which is small enough to install on the stock electric parallel gripper of the robot. Two separate pairs of finger set with grasp ranges varying from 0-68 mm to 68-144 mm were manufactured. In one example, each finger set can comprise an array of eight sensors. Two fingers can be interfaced via an Arduino Uno microcontroller that polls all sixteen sensors in a round-robin fashion. The microcontroller can connect to a control computer and ROS via a USB port, which can also provide the supply voltage for the sensors. Unless otherwise noted, all objects can be chosen from the Yale-CMU-Berkeley (YCB) Object and Model set.

Proximity sensing can first be used to center a gripper 16 around an object. This can be helpful because successful grasping can require both fingers to simultaneously make contact. For example, grasping a cup at its handle induces a turning motion that needs to be counteracted by the opposite finger before the cup has turned out of the robot's grasp. Similarly, removing a block from a Jenga tower requires the gripper to create force-closure with the block while inducing a minimum amount of motion on the block itself.

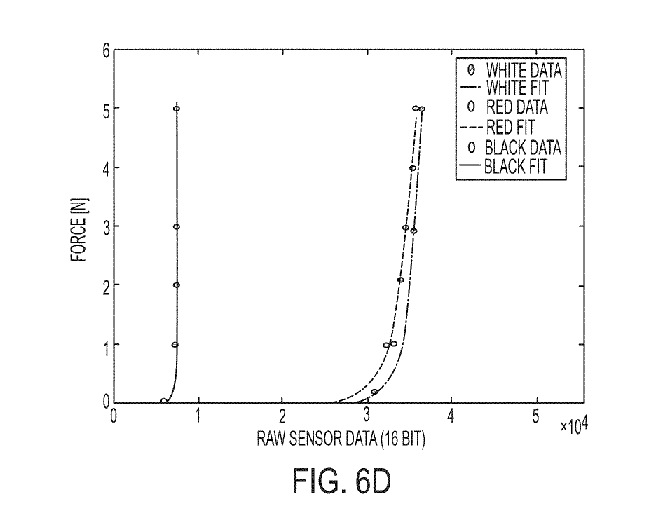

FIG. 7A depicts a similar situation, in which imprecise alignment will collapse a tower of wooden blocks. The grippers 16 were closed in discrete steps and the response from the sensor was recorded. The response from the sensors on the right finger is shown in solid lines and the response from the left finger is shown in dashed lines in FIG. 7B.

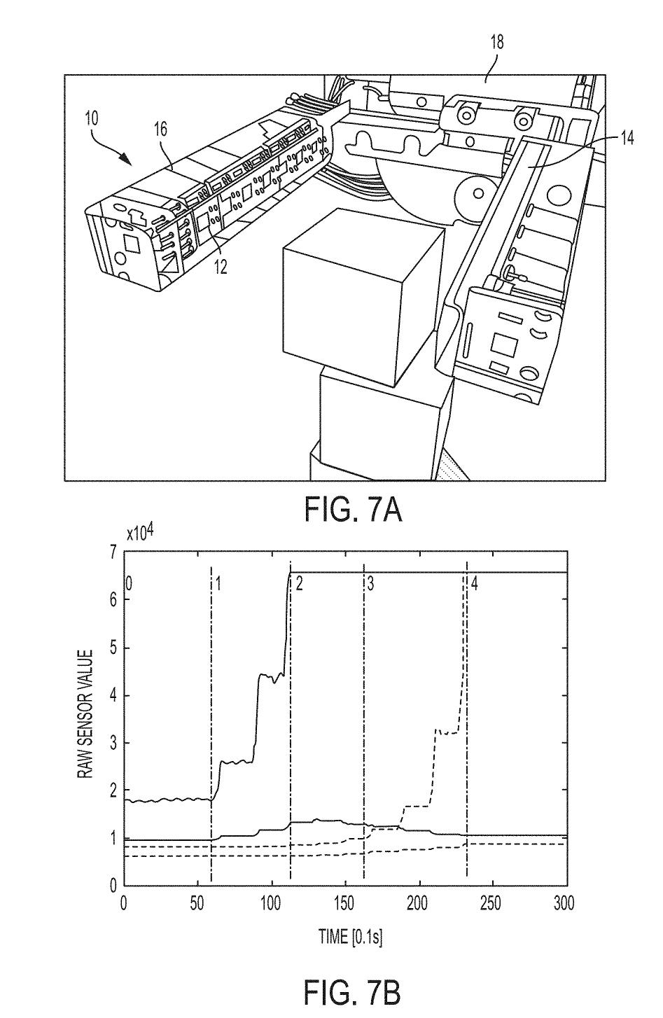

Assuming the surface properties (reflectance) are the same on both sides of the object, data shown in FIG. 8 can be used to servo the end-effector to a position in which both distances are roughly equal using feedback control and inverse kinematics (Baxter SDK PyKDL).

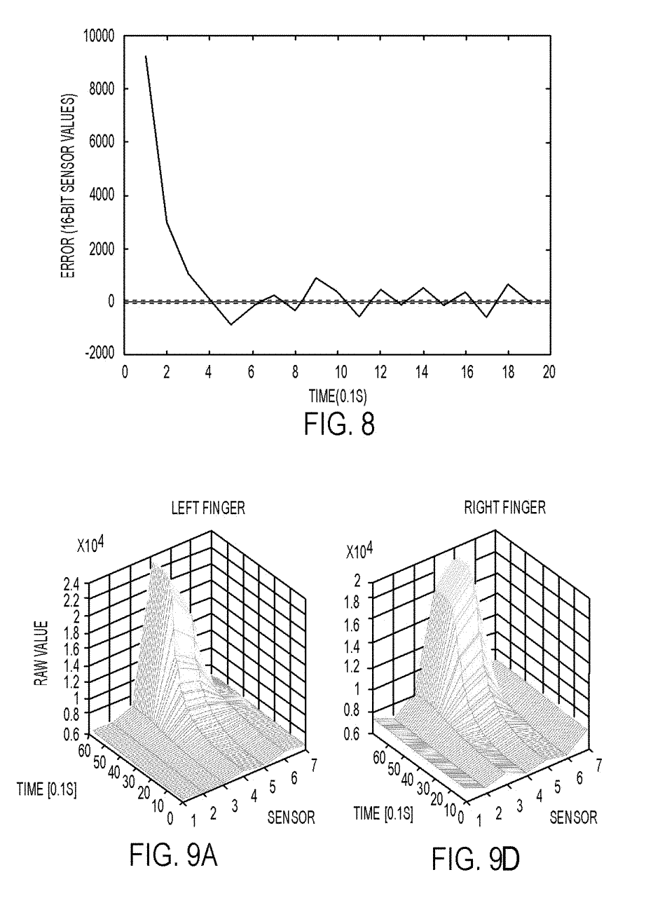

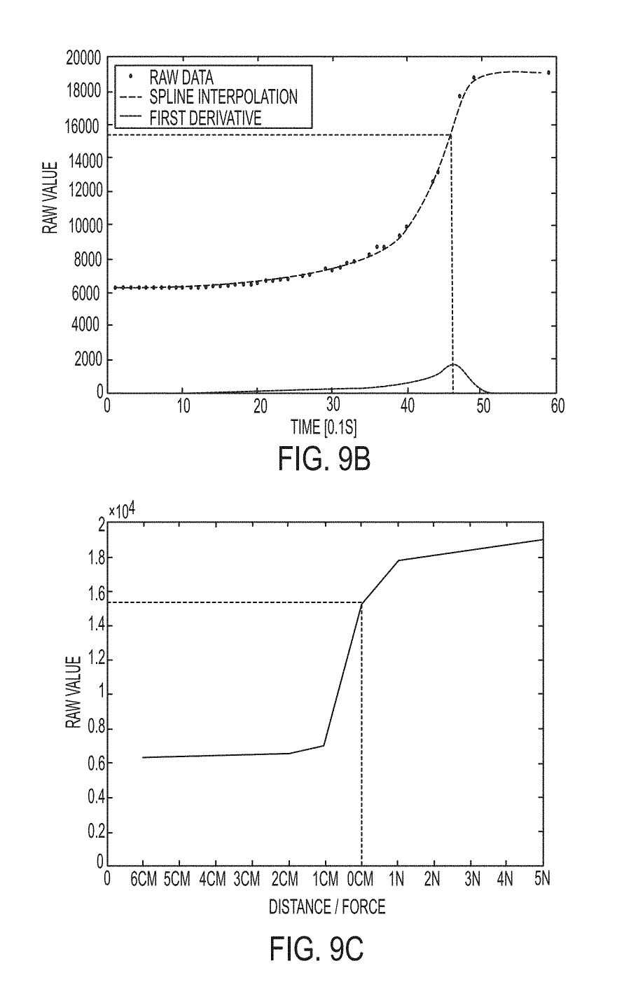

Force sensing can be used to determine the location of incidence of an object on the gripper. FIG. 9A shows the raw measurements of all sensors 12 when grasping the handle of a YCB pan (FIG. 10A). The data shows which sensors made the most contact, letting us infer the approximate size of the object. Closer inspection of contact data, here the 5th sensor of the right finger, reveals that gentle pressure drives the sensor to roughly 2×104 (FIG. 9B), which is similar to values generated by contact with black cardboard (FIG. 9C). Furthermore, fitting a spline to the raw data and calculating its derivative (MATLAB spline and fnder), reveals that the sensor 12 response has an extrema close to where the black cardboard crosses from the distance to the force regime. Performing the same operation on data from the left finger suggests a material of slightly higher reflectance (the sensor maxes out at 2.4×104) with a cross-over point at a raw value of 17529. While not sufficient to determine the actual object properties, the suitability of using extrema on the sensor response (minimum, maximum, and cross-over point) to identify specific materials can be explored in the future. Indeed, the cross over point for all experiments shown in FIG. 6A for currents ranging from 40 mA to 200 mA in increments of 40 mA (25 experiments) can be detected. This suggest that the sensor response indeed follows that of equations 2-4.

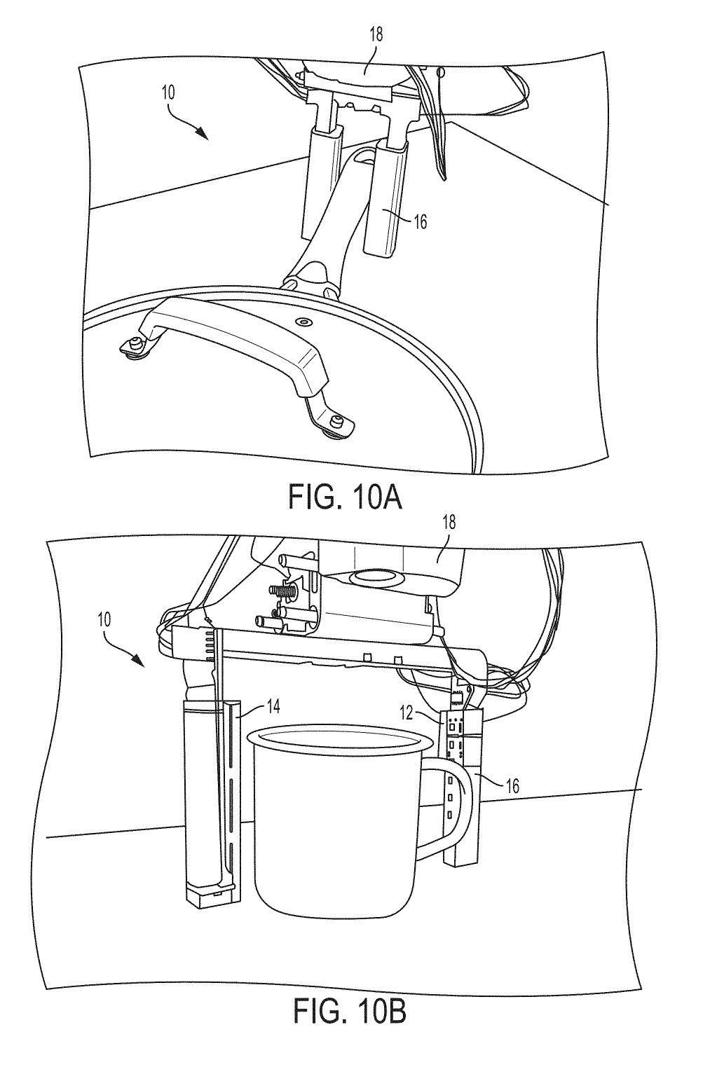

Given the material parameters, in-hand proximity sensing can be used to augment, and possibly register against, conventional 3D sensing. The robot arm can be programmed to reach a specified scanning position on the table in a position shown in FIG. 10B. It can be assumed such a position can be reached using coarse visual or RGB-D data, as well as the proximity sensors themselves. The robot wrist joint can be rotated around the object in increments of 0.17 rad in the interval of [−π;π]. Using the actual encoder value at each step and converting sensor readings into centimeters using (5) yields polar coordinates of each point where the infrared light hits the object. The resulting data is shown in FIG. 11. While noisy due to non-orthogonal incidence angles at the handle and the bottom of the cup, the fidelity of the model is sufficient to highlight the presence of the cup's handle.

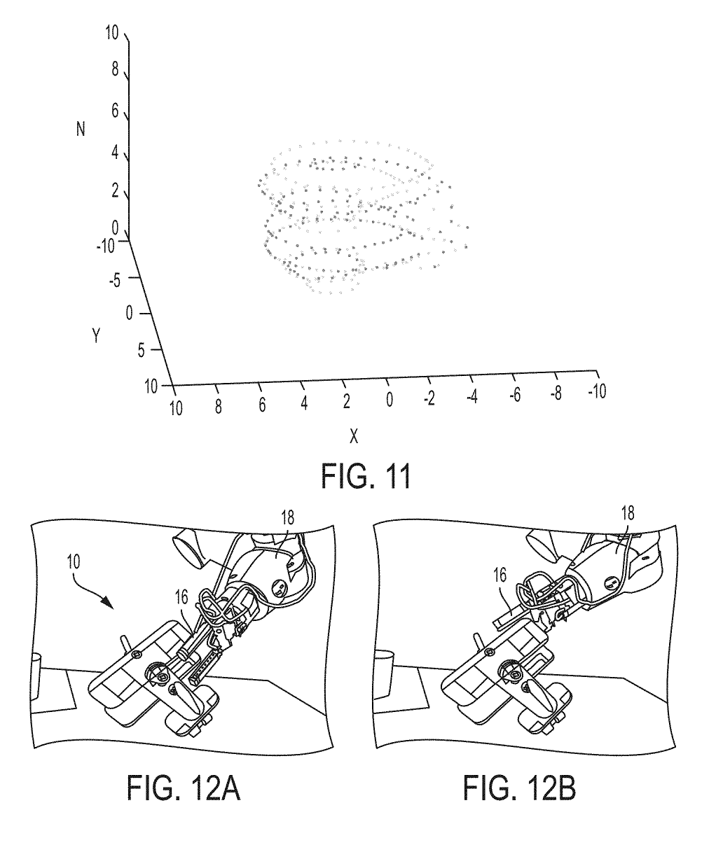

A toy airplane form the YCB object set which has a highly reflecting surface was also selected. FIGS. 12A and 12B show the direction in which the robot wrist is swept across the wing to detect a possible grasp location, this time using a horizontal motion.

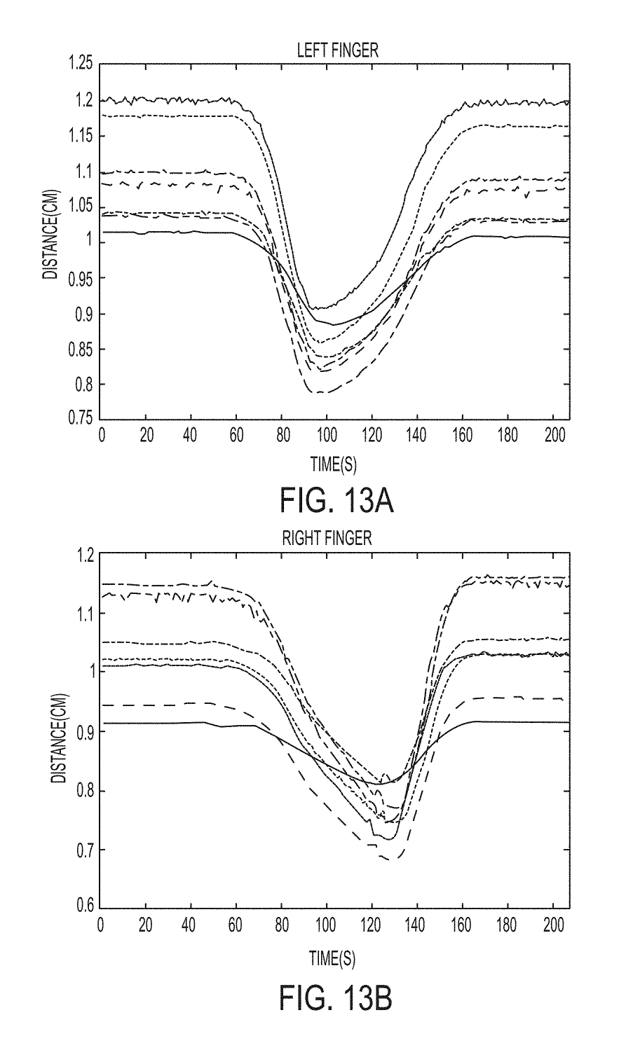

FIGS. 13A and 13B show the response of the sensors 12 to the toy airplane. While the distance measurements are underestimated due to the reflectance of the opposite gripper (at a distance of around 7 cm) and the airplane wing, the presence of the airplane wing is clearly discernible. As the wing starts appearing in the field of view of the sensors a decrease in distance can be seen, which reaches a maximum at the wing's center, and then gradually increases as the robot arm moves away from the wing. This can be due to the fact that the infrared emitter is better approximated by a lobe than by a ray. The symmetry of the reflected plane at the center of the wing can cause the photo receiver to receive the maximum possible reflected intensity available from the airplane wing, illustrating the limitations in lateral resolution, which would need to be compensated by an orthogonal sweep, should a more accurate 3D reconstruction be desired.

The sensor 12 of the present application has a series of design parameters comprising the choice of the material itself, its mixing ratio, its thickness, and the current at which the emitter operates. Each of these parameters can affect the sensors' range, dynamic range, and thereby resolution and accuracy. While far from exhaustive, systematic experiments presented here highlight important trends, and allow obtaining a good trade-off between ranging and force sensing capabilities.

Though roughly following the form y=ax^{b}+c, this approximation introduces non-negligible systematic error, an effect that gets amplified by adding a PDMS layer, which introduces another constant to the denominator of (2). While better non-linear approximations could be found, e.g., using support vector machines or training a neural network, the sensor 12 an be sensitive to surface properties. For example, black paper is five times less reflecting than white paper, whereas shiny objects are more reflecting. However, most practical application of the sensor might not require calibration at all. Indeed, centering around an object only requires equalizing sensor readings, which are both monotonously increasing and continuous from infinity to 5N force.

Moreover, it can be possible for the system 10 to take measurements independently of surface reflectivity by looking at peaks in the derivative of the signal emitted from the sensor 12.

Further, the shape of the function that relates distance/force/contact measurements to raw sensor 12 readings is of similar quality independent of the surface properties, thickness, mixing ratio, and current, with an infliction point at the contact point. Performing a firm grasp on an unknown object such as the panhandle in FIG. 10A allows recording such a curve in its entirety and might allow to infer its material properties given all other parameters of the sensor are known. For example, when squeezing the handle, the sensor 12 reading maxes out at around 2.1×104, which is slightly above the value of black paper at 120 mA (1.8×104) for 6 mm PDMS (8:1). Together with actual distance information obtained from the gripper 16 itself, it might be possible to calibrate the sensor online by performing a simple grasp, and then use this data to perform an accurate 3D reconstruction.

Squeezing an object might also provide insight for tuning the sensing current. For example, the sensor 12 current could be reduced until the sensor saturates at a value below the maximum reading, and calibration data could be obtained during a second squeeze.

Another limitation of optical proximity sensors can be their dependence on the angle of incidence. While this is not noticed with rotation symmetric objects such as those used here, scanning a rectangular object using a circular swivel motion, e.g., could cause the object to appear elliptical. As the resulting error is well quantified, contact information can be exploited to estimate the angle of a surface. Similarly, sensor-based motion planning techniques could allow complete reconstruction of a 3D object and/or registering it with information obtained by other sensors such as vision and depth.

An integrated force, distance and/or contact sensor 12 is provided that can be simple to manufacture and low-cost, yet providing a series of benefits that conventionally required much more complex sensors. As expected with infrared-based sensors, the sensor can be strongly nonlinear, highly sensitive to surface properties and has poor lateral resolution when compared with ray-based or RGBD sensors.

Nevertheless, the sensor has a wide range of use cases that facilitate grasping and manipulation ranging from contact point detection, determining grasp points, to object registration, and can possibly be improved by improved sensor models and sensor-based motion planning strategies. The necessary processing could be co-located with the sensor, allowing it to autonomously identify surface properties of an object and adapt accordingly.

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described invention.

What is claimed is:

1. A measurement system for measuring force, distance and contact for manipulation of an object by a robot, the system comprising:
at least one infrared proximity sensor embedded in a polymer, wherein the at least one embedded sensor is positioned on a portion of the robot.

2. The measurement system of claim 1, wherein the polymer is an elastomer.

3. The measurement system of claim 2, wherein the elastomer is polydimethylsiloxane.

4. The measurement system of claim 2, wherein the elastomer is transparent to infrared light.

5. The measurement system of claim 1, wherein the at least one infrared proximity sensor comprises a plurality of sensors arranged in a predetermined pattern prior to being embedded in the polymer.

6. The measurement system of claim 5, wherein the predetermined pattern comprises at least one array.

7. The measurement system of claim 6, wherein the at least one array comprises a 1×8 array of sensors.

8. The measurement system of claim 6, wherein the at least one array comprises a first 4×8 array of sensors.

9. The measurement system of claim 8, wherein the at least one array comprises a second 4×8 array of sensors interleaved with the first 4×8 array of sensors.

10. The measurement system of claim 6, wherein the at least one embedded sensor is positioned on a portion of a gripper of the robot.

11. The measurement system of claim 10, wherein the at least one array comprises a first array positioned on a first finger of the robotic gripper and a second array positioned on a second finger of the robotic gripper.

12. The measurement system of claim 1, wherein the at least one infrared proximity sensor is configured to provide at least one of force, distance and contact data to a processor.

13. The measurement system of claim 12, wherein contact is determined by the system when a distance from the robot to a portion of the object is zero and when a force exerted by the robot on the portion of the object is zero.

14. The measurement system of claim 13, wherein contact is measured by the at least one infrared proximity sensor optically.

15. A method of measuring force, distance and contact for manipulation of an object by a robot, the method comprising:
providing at least one infrared proximity sensor;
embedding the at least one proximity sensor in a polymer;
positioning the at least one embedded sensor on a portion of the robot; and
moving the at least one embedded sensor around the robot.

16. The method of claim 15, wherein the polymer is an elastomer transparent to infrared light.

17. The method of claim 16, wherein the at least one infrared proximity sensor comprises a plurality of sensors arranged in a predetermined pattern prior to being embedded in the polymer.

18. The method of claim 14, wherein the at least one infrared proximity sensor is configured to provide at least one of force, distance and contact data to a processor.

19. The method of claim 18, wherein contact is determined by the processor when a distance from the robot to a portion of the object is zero and when a force exerted by the robot on the portion of the object is zero.

20. The method of claim 19, wherein contact is measured by the infrared proximity sensor optically.
